(19) United States
(12) Patent Application Publication
(10) Pub. No.: US 2010/0052433 A1
(43) Pub. Date: Mar. 4, 2010

(54) CIRCUIT ARRANGEMENT, SWITCH DEVICE, AND METHOD FOR CURRENTLESS SWITCHING OF A POWER CIRCUIT OF A CIRCUIT ARRANGEMENT

(76) Inventors: Andreas FRIESE, Pfalzgrafenweiler (DE); Andreas Kynast, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/542,955

(22) Filed: Aug. 18, 2009

(30) Foreign Application Priority Data
Aug. 29, 2008 (DE) 10 2008 041 725.4

(51) Int. Cl. H01H 9/00

(52) U.S. Cl. 307/113; 200/42.01

(57) ABSTRACT

The present invention relates to a circuit arrangement, having a power circuit and a control circuit, in which the power circuit with the control circuit is activatable and deactivatable, and the power circuit is activatable only when the power circuit is switched on and is deactivatable only as long as the power circuit is switched on. The present invention further relates to a switch device, which includes an actuator as well as a first switch for switching a power circuit and a second switch for switch a control circuit of a circuit arrangement, in which the first switch and the second switch are switchable by actuation of the actuator, and the second switch is switchable only when the first switch is switched. The present invention also relates to a method by which a power circuit of a circuit arrangement, is activatable or deactivatable, in which the circuit arrangement includes the power circuit and a control circuit, and the power circuit is switched on before it is activated by switching on of the control circuit. The present invention also relates to a handheld electric power tool, including a switch device.

### CROSS-REFERENCE TO RELATED APPLICATION

This application is based on German Patent Application 10 2008 041 725.4 filed Aug. 29, 2008.

### BACKGROUND OF THE INVENTION

1. Field of the Invention

The present invention relates to a circuit arrangement with a power circuit and a control circuit, to a switch device, and to a method with which a power circuit of a circuit arrangement, in particular a circuit arrangement according to the invention, is activatable or deactivatable, as well as to a handheld electric power tool that includes a switch device.

2. Description of the Prior Art

When electrical units are switched on and off, a distinction is made between switching strong currents in power circuits and switching weak currents in control circuits. This is because when switches in power circuits are opened, because of the strong currents flowing then, electric arcs often occur, which lead to sticking and fusing of the electrical contacts in the switch. Moreover, a mechanical separation from electrical circuits is required, for instance when lithium-ion batteries are used.

### OBJECT AND SUMMARY OF THE INVENTION

It is the object of the present invention to create an inexpensive circuit arrangement, an inexpensive switch device, and an inexpensive method with which a power circuit is switchable, without causing fusing or sticking of the switches used.

The object is attained with a circuit arrangement having a power circuit and a control circuit, in which the power circuit is activatable and deactivatable with the control circuit, and the power circuit is activatable only when the power circuit is switched on and is deactivatable only as long as the power circuit is switched on.

In a power circuit in terms of the invention, in the activated state currents flow that are strong enough to cause electric arcs when a switch disposed in the power circuit is opened, and these electric arcs can cause the contacts of the switch to fuse or stick and can therefore lead to major wear or even the destruction of the switch. In contrast to this, in a control circuit in terms of the invention, weak enough currents flow that upon opening of a switch disposed in the control circuit, an electric arc that leads to major wear or even the destruction of the switch does not occur.

Moreover, the activation of the power circuit by the control circuit in terms of the invention makes a current flow in the power circuit possible even though the current flow in the power circuit has ended as a result of the deactivation. It should be taken into account that inductive and possibly also capacitive transient behavior of the circuit arrangement can lead to a slight time lag, which upon activation, for instance, causes an increase in the current flow or upon deactivation causes a decrease in the current flow.

According to the invention, the power circuit is not activated by the control circuit until the power circuit is already switched on. Since the activation of the power circuit by the control circuit is what makes the current flow in the power circuit possible, the switching on of the power circuit takes place while the power circuit is currentless.

Moreover according to the invention, the power circuit is deactivated by the control circuit, and therefore the current flow in the power circuit is ended, while the power circuit is still switched on. Since the deactivation of the power circuit by the control circuit ends the flow of current in the power circuit, switching off the power circuit takes place while the power circuit is essentially currentless. The term “essentially” refers to the aforementioned inductive and optionally capacitive transient behavior of the circuit arrangement and has the same meaning hereinafter as well.

Since the switching on and off of the power circuit takes place with the power circuit essentially currentless, electric arcs that cause fusing or sticking of switches cannot occur at all any longer, so that for switching the power circuit, an inexpensive switch can be used. This is because the switch merely needs to carry the current of the power circuit, but does not have to switch it.

In contrast to switching of the power circuit in an essentially currentless state, the control circuit is switched even though current can flow in the control circuit. Accordingly, the control circuit need not be activated or deactivated. The switching of the control circuit is therefore distinguished from the switching of the power circuit, in that the current in the control circuit can flow even upon switching. However, only a weak current flows in the control circuit, so that upon switching of the control circuit, and specifically both upon activatable and deactivatable of the power circuit, only a weak current is switched. The switching of the control circuit furthermore does not lead to major wear of the switch used, so that even for switching the control circuit, an inexpensive switch can be used.

For switching the power circuit and for switching the control circuit, the same switch is especially preferably used, making the switches inexpensive because of the large numbers produced.

Preferably, the activatable and deactivatable of the power circuit is effected essentially upon switching of the control circuit. Accordingly, the switching on of the control circuit takes place with a time lag after the switching on of the power circuit, and switching off the power circuit takes place with a time lag after the switching off of the control circuit. Because of the time lag, the switching on and off of the power circuit takes place with the circuit arrangement essentially in its steady state. The switching on and off of the power circuit therefore takes place with an essentially currentless power circuit.

The switching of the power circuit and/or the control circuit furthermore takes place preferably mechanically and/or electrically. As the switch, a switch that remains stably in its switching state, such as a bistable multivibrator, a relay, a contactor, or a stepping switch. However, the use of a button or a monostable multivibrator switch that returns to its outset state when the actuation force is withdrawn is also possible. Since the power circuit and the control circuit are switched in chronological succession, the switching in succession can be done mechanically. Such mechanical switching of the power circuit and/or the control circuit in succession can be achieved mechanical at little effort or expense. As long as the chronological course shown in FIG. 4 is maintained upon switching, arbitrary switches can be used.

Preferably, the activatable and deactivatable of the power circuit is effected electrically, in particular by means of power semiconductors. The signal circuit accordingly activates the power circuit electrically, in particular by means of power semiconductors. As power semiconductors for the activatable and deactivatable of the power circuit, one or more (bipolar) transistors, MOSFETs (metal oxide semiconductor field effect transistors), thyristors, IGBTs (insulated gate bipolar transistors), triacs (triode alternating current switches) or integrated circuits (ICs) can be used. Arbitrary combinations of power semiconductors are also conceivable, such as full bridges, half bridges, cascades, and so forth.

Accordingly, the power circuit is activated by switching on a weak current in the control circuit, and the strong current is switched on in the power circuit, and by the switching off of a weak current in the control circuit, the power circuit is deactivated and a strong current in the power circuit is switched off.

The object is further attained with a switch device, which includes an actuator as well as a first switch for switching a power circuit and a second switch for switch a control circuit of a circuit arrangement. The first switch and the second switch arc turned on and off by actuation of the actuator. The second switch is able to be turned on and off only when the first switch is switched.

According to the invention, the first switch and the second switch are switched in succession by actuation of the actuator, and specifically the second switch, which switches the control circuit, is switched after the first switch has switched the power circuit on. Since the power circuit is activated or deactivated by the switching on of the control circuit, the first switch that switches the power circuit always switches the power circuit when the power circuit is in an essentially currentless state. Therefore, since both switches switch only a weak current or even switch in currentless fashion, inexpensive switches can be used.

Preferably, the first switch and the second switch are disposed spatially offset from one another, and/or that the actuator includes a structure, so that upon actuation the actuator cooperates successively with one of the two switches and switches it. A switch device of this kind is feasible inexpensively at little effort. Moreover, structurally identical switches can be used, and thus the costs of the switch device are reduced because of the high numbers of switches produced.

The object is also attained with a method by which a power circuit of a circuit arrangement is activatable or deactivatable and in which the circuit arrangement includes the power circuit and a control circuit, and the power circuit is switched on before it is activated by switching on of the control circuit. Since the power circuit is not activated until the control circuit is switched on, the switching on of the power circuit takes place in the currentless state.

Preferably, the control circuit is switched off and the power circuit is thereby deactivated, before the power circuit is switched off. Since the switching off of the power circuit does not occur until the power circuit is deactivated by switching off the control circuit, the switching off of the power circuit also takes place in an essentially currentless state.

Therefore, as switches for switching the power circuit, an inexpensive switch can be used. Since in the control circuit, only weak currents ever flow, inexpensive switches can also be used for switching the control circuit.

Preferably, the power circuit and the control circuit are both switched with a switch device of the invention, so that the method can be realized with inexpensive switches and in particular in a very simple way mechanically.

The object is also attained with a handheld electric power tool that includes a switch device of the invention. A handheld electric power tool is for example hedge clippers, a circular saw, compass saw, or chainsaw, a power drill, or some other power tool used in a workshop, in the garden, or in the household. However, the invention is not limited to these applications and can instead be employed in any other industrial field, such as the automotive field.

### BRIEF DESCRIPTION OF THE DRAWINGS

The invention will be better understood and further objects and advantages thereof will become more apparent from the ensuing detailed description of preferred embodiments taken in conjunction with the drawings, in which:

FIG. 1 schematically shows a circuit arrangement of the invention;

FIG. 2 a-c shows a switch device of the invention for switching both a power circuit and a control circuit of a circuit arrangement of the invention;

FIG. 3 a-c shows variants of a switch device of the invention; and

FIG. 4 a-c shows the course over time between the switching of a first switch and of a second switch of a switch device of the invention and the current flowing in the power circuit of a circuit arrangement of the invention.

### DESCRIPTION OF THE PREFERRED EMBODIMENTS

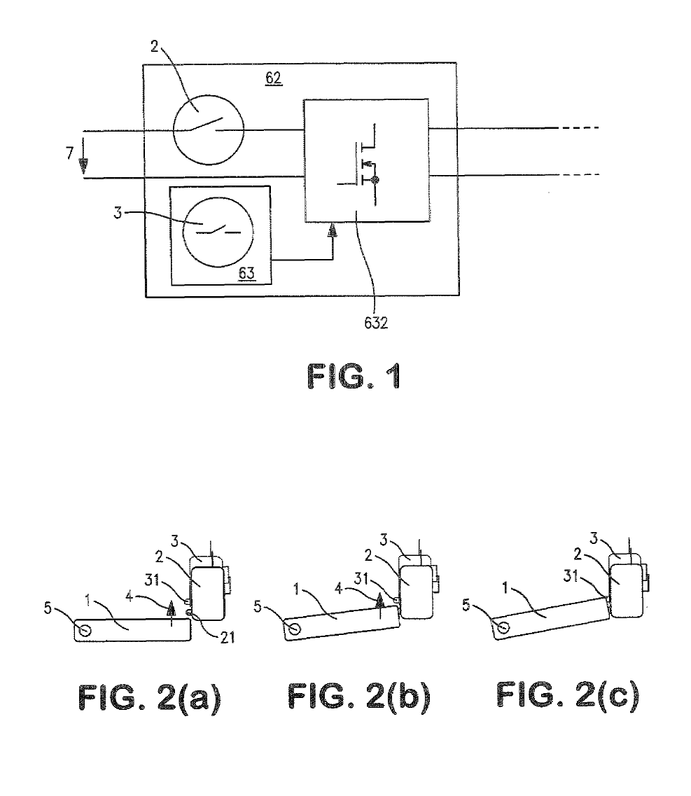

FIG. 1 schematically shows a circuit arrangement of the invention, which includes both a power circuit 62 with a first switch 2 and a control circuit 63 with a second switch 3. By actuation of the first switch 2, the power circuit 62 is indeed switched on, but no current can yet flow. Once the first switch 2 in the power circuit 62 has switched on, the second switch 3 in the control circuit 63 is actuated, so that a power semiconductor 632 which is disposed between the power circuit 62 and the control circuit 63 and which activates the power circuit 62, switches, so that a current can now flow in the power circuit 62 as well. Examples of power semiconductors 632 are a bipolar transistor, a MOSFET, a thyristor, a triac, an IC, or an IGBT. Either one or more power semiconductors 632 may be employed, which can be interconnected in a full bridge circuit, half bridge circuit, cascade circuit, or the like. As output voltage 7, the power circuit 62 furnishes one or more output voltages, which may for instance be pulse width modulated, or a single- or multi-phase output alternating voltage. As input voltage, a direct voltage or a single- or multi-phase alternating voltage is possible, provided in particular by a lithium-ion battery. The protection of the switch is independent of the type of voltage source, so that the input voltage can also be furnished by an arbitrary other input voltage source, such as a lead battery or other types of battery, an AC connection, and so forth.

FIG. 2 shows a switch device for switching both a power circuit 62 and a control circuit 63 of the circuit arrangement of the invention shown in FIG. 1. The switch device has an actuation means 1, in this case an actuation lever, with which a first switch 2 and a second switch 3 are switchable. Hereinafter, the term actuation lever 1 will therefore be used synonymously with the term actuation means 1. In general, classical switches that are mechanically actuated are provided as both the first switch 2 and the second switch 3. However, as long as the switching times in accordance with FIG. 4 are adhered to, still other switch means are also possible, such as relays, buttons, or others. The actuation lever 1 is supported rotatably about a shaft 5, as shown in FIG. 2a), and is therefore rotated upon actuation. As a result of rotation of the actuation lever 1 about the shaft 5 in a direction of rotation 4 that is indicated by an arrow, the actuation lever 1, on its end diametrically opposite the shaft 5, comes in contact with an actuation means 21 of the first switch 2 and switches the first switch 2, as shown in FIG. 2b). As a result, the power circuit 62 of the circuit arrangement of the invention is switched on, without a current I being capable of flowing in the power circuit 62. After that, by further rotation of the actuation lever 1 in the same direction of rotation 4, the actuation lever 1, with its end diametrically opposite the shaft 5, comes into contact with an actuation means 31 of the second switch 3 and switches the second switch 3, as shown in FIG. 2c). As a result, the control circuit 63 of a circuit arrangement of the invention is switched, so that the power circuit 62 is activated, and a current I can flow in the power circuit 62. The two switches 2, 3 are therefore switched in succession.

The successive switching of the first switch 2 and second switch 3 is attained mechanically in such a way that the switches 2, 3 are disposed spatially offset from one another, so that it is assured that the actuation lever 1 will not switch the first switch 2 and the second switch 3 simultaneously. By reverse rotation counter to the direction of rotation 4, the contact of the end of the actuation lever 1 opposite the shaft 5 with the actuation means 31 of the second switch 3 is first undone, so that the second switch 3 is switched. As a result, the control circuit 63 is switched off and thus the power circuit 62 is also deactivated, so that the current flow in the power circuit 62 is ended. After that, the contact of the end of the actuation lever 1 opposite the shaft 5 with the actuation means 21 of the first switch 2 is undone, so that the first switch 2 is switched and therefore the power circuit 62 is switched off.

In the final analysis, for switching the power circuit 62 on and off, two switches 2, 3 which are actuated mechanically in succession are therefore used—specifically, the first switch 2, which is actuated first upon switching on of the power circuit 62, which switches the power circuit 62, and the second switch 3 then actuated, which switches the control circuit 63 and as a result via power semiconductors 632 activates the power circuit 62. Upon switching off, the second switch 3, which is the first one actuated, switches the control circuit 63, so that the power circuit 62 is deactivated, and the first switch 2, which is actuated after the second switch, switches the power circuit 62.

A switch device for switching a circuit arrangement of the invention is realized in the form of a pressure switch, for instance. Other possible switch devices are a lever, a rocker, a slide, a rotary knob, other mechanical arrangements, relays, or contactor circuits.

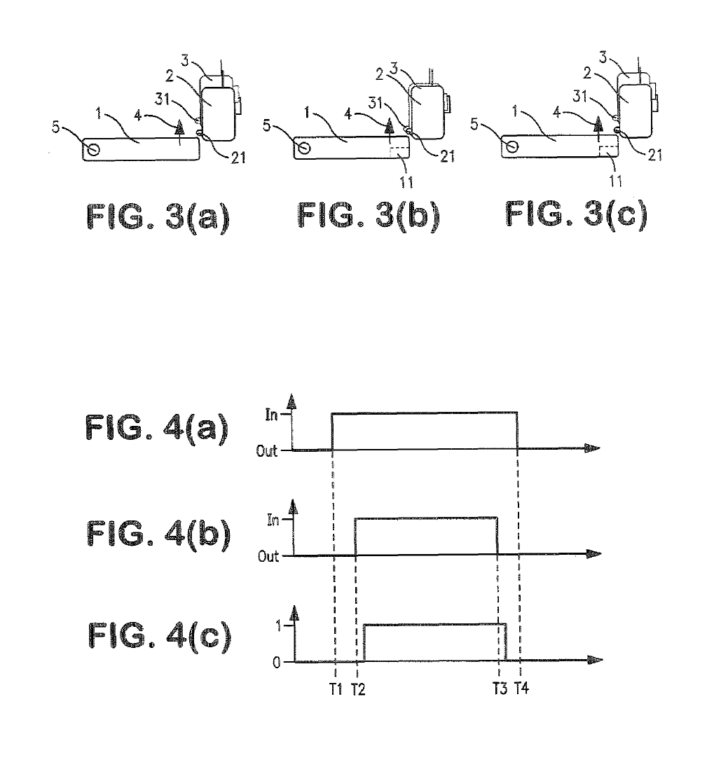

FIG. 3 shows variants of a switch device for switching a circuit arrangement 6 of the invention. In the variant in FIG. 3B), the successive switching of the first switch 2 and second switch 3 is attained by providing that the switches 2, 3 are not offset spatially but rather disposed in the same plane, but the actuation lever 1 has a structure 11, such as a step or ramp, so that upon rotation of the actuation lever 1, the actuation means 21 of the first switch 2 comes into contact with the end of the actuation lever 1 opposite the shaft 5 earlier than does the actuation means 31 of the second switch 3, and so that upon reverse rotation of the actuation lever 1, counter to the direction of rotation 4, the contact of the actuation lever 1 with the actuation means 31 of the second switch 3 is undone earlier than the contact with the actuation means 21 of the first switch 2. In the variant in FIG. 3C), a combination of the switch devices of the variants in FIG. 3B) and FIG. 3A) is shown. In this variant, therefore not only does the actuation lever 1 have a structure 11 that brings about the time lag between the switching of the first switch 2 and of the second switch 3, but furthermore, the first switch 2 and the second switch 3 are disposed spatially offset from one another.

FIGS. 1 and 2 both show the inexpensive use of structurally identical switches 2, 3. However, it is also possible to use two different types of switch and switch techniques.

FIG. 4 shows the course over time between the switching of the first switch 2 and of the second switch 3 of a switch device of the invention in the variants shown in FIG. 2 and in FIGS. 3A)-C) and the current I flowing in the power circuit 62 of a circuit arrangement of the invention. FIG. 4a) shows the switching state of the first switch 2, which switches the power circuit 62 of a circuit arrangement 6 of the invention, and FIG. 4b) shows the switching state of the second switch 3, which switches the control circuit 63 of a circuit arrangement 6 of the invention. Finally, FIG. 4c) shows the course of the current I in the power circuit 62.

At time T1, first switch 2 is actuated by rotation of the actuation lever 1 about the direction of rotation 4 and closes the power circuit 62. By further rotation of the actuation lever 1 in the direction of rotation 4, the second switch 3 is switched, so that at time T2, the control circuit 63 closes. As a result, in particular via power semiconductors 632, the control circuit 63 activates the power circuit 62, whose current I then rises, optionally with a slight time lag. The slight time lag is due to the fact that the inductive components of the circuit arrangement possibly delay the current rise. By reverse rotation of the actuation lever 1, the contact of the actuation lever 1 with the actuation means 31 of the second switch 3 is first undone, so that at time T3, the second switch 3 is switched off and the control circuit 63 is opened. As a result, via the power semiconductors 632, the control circuit 63 deactivates the power circuit 62, whose current I thereupon drops, perhaps with a slight time lag because of the topology of the circuit arrangement. If the actuation lever 1 is rotated still farther counter to the direction of rotation 4, then the contact of the actuation lever 1 with the actuation means 21 of the second switch 2 is broken as well, so that the second switch switches off and the power circuit 62 is therefore opened. At the instant of this switching of the first switch 2, the power circuit 62 is no longer carrying any current, so that at that time, the power circuit 62 is essentially currentless.

The foregoing relates to preferred exemplary embodiments of the invention, it being understood that other variants and embodiments thereof are possible within the spirit and scope of the invention, the latter being defined by the appended claims.

We claim:

1. A circuit arrangement, having
a power circuit and a control circuit, the power circuit being activatable and deactivatable by the control circuit, and the power circuit being activatable only when the power circuit is switched on and being deactivatable only during when the power circuit is switched on.

2. The circuit arrangement as defined by claim 1, wherein the activation and the deactivation of the power circuit are effected essentially upon switching of the control circuit.

3. The circuit arrangement as defined by claim 1, wherein the switching of the power circuit and/or of the control circuit is effected mechanically and/or electrically.

4. The circuit arrangement as defined by claim 1, wherein the switching of the power circuit and/or of the control circuit is effected mechanically and/or electrically.

5. The circuit arrangement as defined by claim 1, wherein the activation and deactivation of the power circuit is effected electrically, in particular by a power semiconductor.

6. The circuit arrangement as defined by claim 2, wherein the activation and deactivation of the power circuit is effected electrically, in particular by a power semiconductor.

7. The circuit arrangement as defined by claim 3, wherein the activation and deactivation of the power circuit is effected electrically, in particular by a power semiconductor.

5. A switch device, which includes an actuator as well as a first switch for switching a power circuit and a second switch for switch a control circuit of a circuit arrangement as defined by claim 1, wherein the first switch and the second switch are switchable by actuation of the actuator, and the second switch is switchable only when the first switch is switched.

8. A switch device, which includes an actuator as well as a first switch for switching a power circuit and a second switch for switch a control circuit of a circuit arrangement as defined by claim 3, wherein the first switch and the second switch are switchable by actuation of the actuator, and the second switch is switchable only when the first switch is switched.

10. A switch device, which includes an actuator as well as a first switch for switching a power circuit and a second switch for switch a control circuit of a circuit arrangement, as defined by claim 6, wherein the first switch and the second switch arc switchable by actuation of the actuator, and the second switch is switchable only when the first switch is switched.

11. The switch device as defined by claim 5, wherein the first switch and the second switch are disposed spatially offset from one another, and/or that the actuator includes a structure, so that upon actuation the actuator cooperates successively with one of the two switches and switches it.

12. A method by which a power circuit of a circuit arrangement as defined by claim 1, is activatable or deactivatable, wherein the circuit arrangement includes the power circuit and the control circuit, and the power circuit is switched on before it is activated by switching on of the control circuit.

13. A method by which a power circuit of a circuit arrangement as defined by claim 2, is activatable or deactivatable, wherein the circuit arrangement includes the power circuit and the control circuit, and the power circuit is switched on before it is activated by switching on of the control circuit.

14. A method by which a power circuit of a circuit arrangement as defined by claim 5, is activatable or deactivatable, wherein the circuit arrangement includes the power circuit and the control circuit, and the power circuit is switched on before it is activated by switching on of the control circuit.

15. The method as defined by claim 12, wherein the control circuit is switched off and the power circuit is thereby deactivated, before the power circuit is switched off.

16. The method as defined by claim 14, wherein the control circuit is switched off and the power circuit is thereby deactivated, before the power circuit is switched off.

17. The method as defined by claim 12, characterized in that the power circuit and the control circuit are switched with a switch device which includes an actuator as well as a first switch for switching the power circuit and a second switch for switch the control circuit, wherein the first switch and the second switch are switchable by actuation of the actuator, and the second switch is switchable only when the first switch is switched.

18. The switch device as defined by claim 17, wherein the first switch and the second switch are disposed spatially offset from one another, and/or that the actuator includes a structure, so that upon actuation the actuator cooperates successively with one of the two switches and switches it.

19. A handheld electric power tool, including a switch device as defined by claim 8.

20. The switch device as defined by claim 19, wherein the first switch and the second switch are disposed spatially offset from one another, and/or that the actuator includes a structure, so that upon actuation the actuator cooperates successively with one of the two switches and switches it.
